(19) United States
(12) Patent Application Publication
(10) Pub. No.: US 2020/0373654 A1
(43) Pub. Date: Nov. 26, 2020

(54) ANTENNA APPARATUS

(71) Applicant: DENSO TEN Limited, Kobe-shi (JP)

(72) Inventors: Masashi SHUKUTANI, Kobe-shi (JP); Tetsuro OKANO, Kobe-shi (JP); Kenji KAWAI, Kobe-shi (JP)

(73) Assignee: DENSO TEN Limited, Kobe-shi (JP)

(21) Appl. No.: 16/834,128

(22) Filed: Mar. 30, 2020

(30) Foreign Application Priority Data
May 24, 2019 (JP) 2019-097965

(51) Int. Cl. H01Q 1/38; H01Q 5/30; H01Q 1/32; H01Q 1/36

(52) U.S. Cl. CPC H01Q 1/38; H01Q 1/36; H01Q 1/32; H01Q 5/30

(57) ABSTRACT

An antenna apparatus includes a first antenna that is arranged within a predetermined area on a dielectric substrate and receives a radio wave in a first frequency band, a second antenna that is arranged in a position within the predetermined area different from the first antenna and receives a radio wave in a second frequency band, and a third antenna that is arranged in a position within the predetermined area different from the first antenna and different from the second antenna and receives a radio wave in a third frequency band. An area of the predetermined area is smaller than a sum of a minimum rectangular area including the first antenna, a minimum rectangular area including the second antenna and a minimum rectangular area including the third antenna.

### BACKGROUND OF THE INVENTION

### Field of the Invention

The invention relates to an antenna apparatus.

### Description of the Background Art

An on-vehicle antenna that is mounted on various vehicles is used so that a vehicle, such as an automobile, can receive an AM (Amplitude Modulation) broadcast radio wave, an FM (Frequency Modulation) broadcast radio wave, a DAB (Digital Audio Broadcasting) broadcast radio wave (or DTV (Digital Television) broadcast radio wave), etc. even when the vehicle is moving. Since the number of devices to be mounted on the vehicle is increasing, it is desirable that an area of the on-vehicle antenna be reduced.

In the vehicle, an antenna apparatus that receives the AM broadcast radio wave, the FM broadcast radio wave, and the DAB broadcast radio wave (or the DTV broadcast radio wave) is prepared so as to be able to receive the AM broadcast radio wave, the FM broadcast radio wave, and the DAB broadcast radio wave (or the DTV broadcast radio wave). However, since the vehicle has a limited space for mounting the antenna apparatus, it is preferable that the antenna apparatus is minimized.

### SUMMARY OF THE INVENTION

According to one aspect of the invention, an antenna apparatus includes a dielectric substrate, a first antenna element that is arranged within a predetermined area on the dielectric substrate and receives a first radio wave in a first frequency band, a second antenna element that is arranged within the predetermined area on the dielectric substrate and receives a second radio wave in a second frequency band different from the first frequency band, and a third antenna element that is arranged within the predetermined area on the dielectric substrate and receives a third radio wave in a third frequency band different from the first frequency band and different from the second frequency band. The first antenna element is arranged in a first portion of the predetermined area on the dielectric substrate. The second antenna element is arranged in a second portion of the predetermined area on the dielectric substrate in which the first antenna element is not arranged. The third antenna element is arranged in a third portion of the predetermined area on the dielectric substrate in which the first antenna element and the second antenna element are not arranged. The first antenna element is contained within a first rectangular area that is within the predetermined area. The first rectangular area is a smallest rectangle that circumscribes the first antenna element. The second antenna element is contained within a second rectangular area that is within the predetermined area. The second rectangular area is a smallest rectangle that circumscribes the second antenna element. The third antenna element is contained within a third rectangular area that is within the predetermined area. The third rectangular area is a smallest rectangle that circumscribes the third antenna element. An area of the predetermined area is smaller than a sum of areas of the first rectangular area, the second rectangular area and the third rectangular area.

An object of the invention is to provide a multi-band compatible antenna apparatus capable of suppressing sensitivity reduction while reducing an area of the antenna.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates a configuration example of an antenna apparatus according to a comparative example;

FIG. 2 illustrates a configuration example of an antenna apparatus according to an embodiment;

FIG. 3 illustrates an example of a functional block of the antenna apparatus according to the embodiment;

FIG. 4 illustrates an example of each antenna element;

FIG. 5 illustrates an example in which the antenna apparatus is mounted on a vehicle; and

FIG. 6 illustrates a configuration example of an antenna apparatus according to a modification example.

### DESCRIPTION OF THE EMBODIMENTS

An embodiment of the invention will be described below with reference to the drawings. A configuration of the embodiment is an exemplification, and a configuration of the invention is not limited to a specific configuration of the embodiment of the disclosure. In implementing the invention, a specific configuration according to the embodiment may be adopted as appropriate.

### Comparative Example

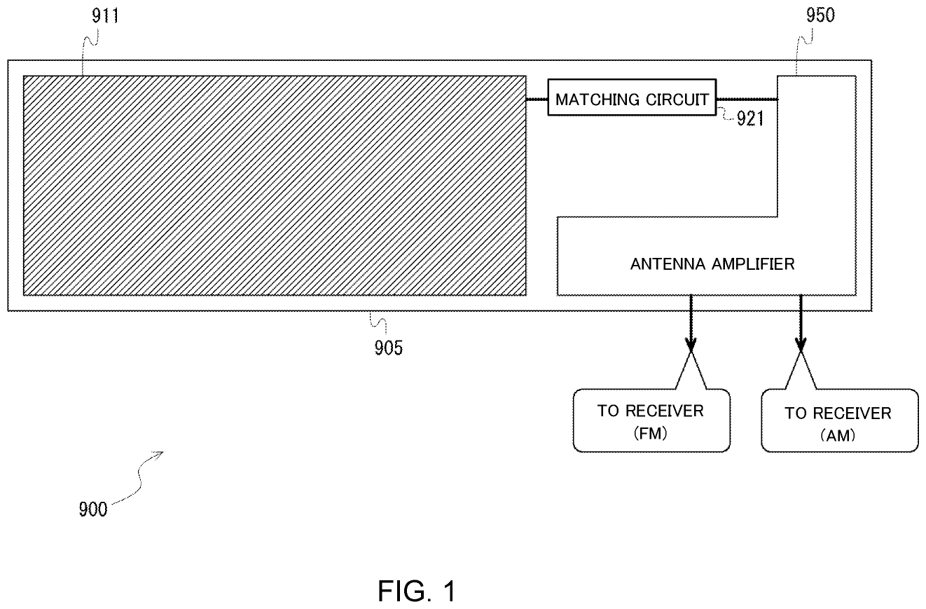

FIG. 1 illustrates a configuration example of an antenna apparatus according to a comparative example. An antenna apparatus 900 includes a substrate 905, an antenna element 911, a matching circuit 921, and an antenna amplifier 950. The antenna element 911 receives a radio wave in a first frequency band and a radio wave in a second frequency band different from the first frequency band. Here, it is assumed that the first frequency band is a frequency band of AM broadcast and the second frequency band is a frequency band of FM broadcast. The antenna apparatus 900 is mainly mounted on a vehicle, such as an automobile, etc.

The substrate 905 is a dielectric substrate on which the antenna element 911, the matching circuit 921, and the antenna amplifier 950 are arranged. Instead of the substrate 905, glasses for vehicles (a windshield, a roof glass, a door glass, a rear glass, etc.) on which the antenna apparatus 900 is mounted may be used.

The antenna element 911 is a plate-shaped conductor that is arranged on the substrate 905. The conductor is, for example, a metal, such as copper or aluminum. The antenna element 911 is connected to the matching circuit 921 via a wiring line.

The matching circuit 921 is arranged between the antenna element 911 and the antenna amplifier 950 and performs matching of the antenna element 911 and a post-stage circuit so as to receive the radio wave in the first frequency band and the radio wave in the second frequency band. The matching circuit 921 is, for example, an electronic component including a coil, a capacitor, or the like.

The antenna amplifier 950 is a circuit that amplifies and outputs a signal received by the antenna element 911. The antenna amplifier 950 divides the received signal into a signal in the first frequency band and a signal in the second frequency band, and outputs the signals. The antenna amplifier 950 amplifies and outputs the signal for each antenna element. The antenna amplifier 950 outputs the amplified signal to a receiver for each frequency band.

In the antenna apparatus 900, since the signal received by the single antenna element 911 is divided into the signal in the first frequency band and the signal in the second frequency band, a branching loss is caused, so that a sensitivity is reduced.

In order to receive the DAB broadcast radio wave (or the DTV broadcast radio wave), the antenna apparatus for receiving the DAB broadcast radio wave (or the DTV broadcast radio wave) needs to be prepared separately from the antenna apparatus 900 for receiving the AM and FM broadcast radio waves. In the vehicle, in order to receive these radio waves, a space for installing two antenna apparatuses needs to be provided. However, since a number of devices to be mounted on the vehicle is increasing, it is difficult to secure a space in the vehicle.

### Embodiment

### Configuration Example

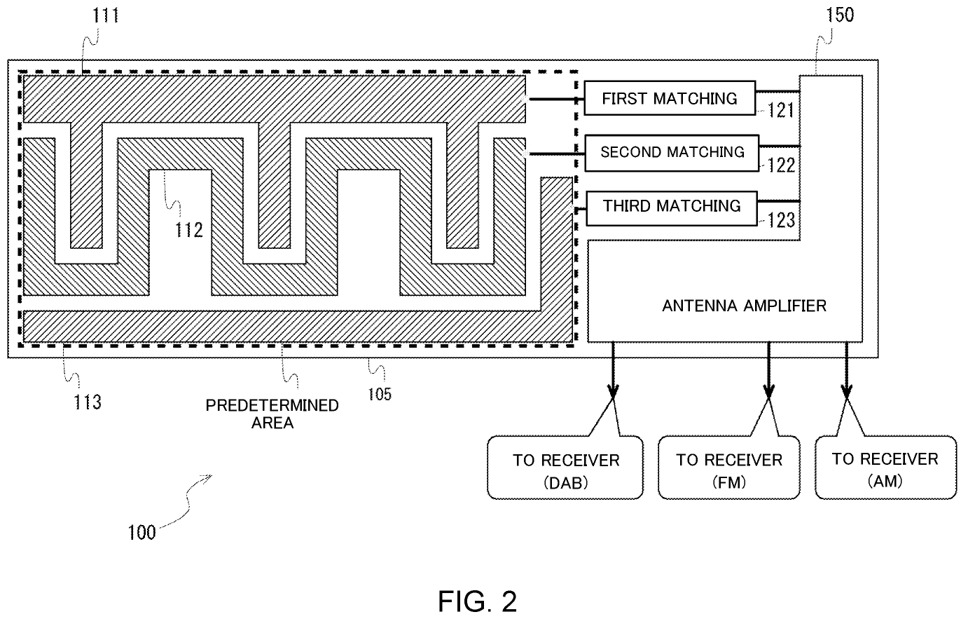

FIG. 2 illustrates a configuration example of an antenna apparatus according to this embodiment. An antenna apparatus 100 includes a substrate 105, a first antenna element 111, a second antenna element 112, a third antenna element 113, a first matching circuit 121, a second matching circuit 122, a third matching circuit 123, and an antenna amplifier 150. The first antenna element 111, the second antenna element 112 and the third antenna element 113 are arranged within a predetermined area (rectangular area surrounded by a dotted line shown in FIG. 2) of the substrate 105. The first antenna element 111 receives a radio wave in a first frequency band. The second antenna element 112 receives a radio wave in a second frequency band different from the first frequency band. The third antenna element 113 receives a radio wave in a third frequency band different from the first frequency band and the second frequency band. Here, it is assumed that the first frequency band is a frequency band of AM broadcast, the second frequency band is a frequency band of FM broadcast, and the third frequency band is a frequency band of DAB broadcast. The frequency band of the AM broadcast is included in a medium frequency band (300 kHz to 3000 kHz). The frequency band of the FM broadcast is included in a very high frequency band (30 MHz to 300 MHz). The frequency band of the DAB broadcast is included in the very high frequency band or an ultra high frequency band (300 MHz to 3000 Mhz). The frequency bands are not limited to these frequency bands. The antenna apparatus 100 is mainly mounted on a vehicle, such as an automobile, etc. The third frequency band may be a frequency band of the DTV broadcast. The frequency band of the DTV broadcast is included in the ultra high frequency band. Since the antenna apparatus 100 receives radio waves in these frequency bands, the AM broadcast, the FM broadcast, the DAB (DTV) broadcast can be listen to in the vehicle.

The substrate 105 is a dielectric substrate on which the first antenna element 111, the second antenna element 112, the third antenna element 113, the first matching circuit 121, the second matching circuit 122, the third matching circuit 123, and the antenna amplifier 150 are arranged. The substrate 105 may have a flat shape or a curved shape. The substrate 105 includes a rigid substrate and a flexible substrate. The substrate 105 is one example of the dielectric substrate. Instead of the substrate 105, glasses for vehicles (a windshield, a roof glass, a door glass, a rear glass, etc.) on which the antenna apparatus 100 is mounted may be used. The glasses are one example of the dielectric substrate.

The first antenna element 111 is a plate-shaped conductor that is arranged in the predetermined area (rectangular area surrounded by a dotted line shown in FIG. 2) on the substrate 105. The conductor is, for example, a metal, such as copper or aluminum. The first antenna element 111 is arranged in the predetermined area so as not to be overlapped with the second antenna element 112 and the third antenna element 113. The first antenna element 111 is connected to the first matching circuit 121 via a wiring line. A connection point between the first antenna element 111 and the wiring line is a feeding point. A wavelength of the first frequency band is sufficiently greater than a wavelength of the first antenna element 111 of the antenna apparatus 100 that is mounted on the vehicle. For example, a wavelength of a radio wave of 1000 kHz is 300 m. Thus, as an area of the first antenna element 111 for the radio wave in the first frequency band is increased, a sensitivity is improved. The sensitivity (gain) of an antenna is represented by, for example, a magnitude of power of a received signal when a wireless signal of predetermined power that is transmitted from a position separated by a predetermined distance is received by the antenna.

The first matching circuit 121 is arranged between the first antenna element 111 and the antenna amplifier 150 and performs matching of the first antenna element 111 and a post-stage circuit so as to receive the radio wave in the first frequency band (frequency band of the AM broadcast). The first matching circuit 121 is, for example, an electronic component including a coil, a capacitor, or the like.

The second antenna element 112 is a plate-shaped conductor that is arranged in the predetermined area (rectangular area surrounded by a dotted line shown in FIG. 2) on the substrate 105. The conductor is, for example, a metal, such as copper or aluminum. The second antenna element 112 is arranged in the predetermined area so as not to be overlapped with the first antenna element 111 and the third antenna element 113. The second antenna element 112 is connected to the second matching circuit 122 via a wiring line. A connection point between the second antenna element 112 and the wiring line is a feeding point. The second antenna element 112 has a meandering shape. The meandering shape has a reciprocating structure in which the conductor is folded a plurality of times into rectangular shapes. By adopting the meandering shape, it is possible to effectively receive the radio wave. A size of a meandering-shaped antenna element (an antenna length, an antenna width, a number of times of folding, folding intervals, a diameter of the conductor, etc.) is determined depending on a frequency band of a radio wave that is received. The shape of the second antenna element 112 is not limited to the meandering shape, and other shapes may be used.

The second matching circuit 122 is arranged between the second antenna element 112 and the antenna amplifier 150 and performs matching of the second antenna element 112 and a post-stage circuit so as to receive the radio wave in the second frequency band (frequency band of the FM broadcast). The second matching circuit 122 is designed to be high impedance for a signal in the third frequency band. The second matching circuit 122 is, for example, an electronic component including a coil, a capacitor, or the like.

The third antenna element 113 is a plate-shaped conductor that is arranged in the predetermined area (rectangular area surrounded by a dotted line shown in FIG. 2) on the substrate 105. The conductor is, for example, a metal, such as copper or aluminum. The third antenna element 113 is arranged in the predetermined area so as not to be overlapped with the first antenna element 111 and the second antenna element 112. The third antenna element 113 is connected to the third matching circuit 123 via a wiring line. A connection point between the third antenna element 113 and the wiring line is a feeding point. The third antenna element 113 has an L shape. The L shape has a structure in which the conductor is folded into an L shape. A size of an L-shaped antenna element (an antenna length, an antenna width, etc.) is determined depending on a frequency band of a radio wave that is received. Since the third antenna element 113 has an L shape, it is possible to contribute to space-saving. The shape of the third antenna element 113 is not limited to the L shape, and other shapes may be used.

The third matching circuit 123 is arranged between the third antenna element 113 and the antenna amplifier 150 and performs matching of the third antenna element 113 and a post-stage circuit so as to receive the radio wave in the third frequency band (frequency band of the DAB broadcast). The third matching circuit 123 is designed to be high impedance for a signal in the second frequency band. The third matching circuit 123 is, for example, an electronic component including a coil, a capacitor, or the like.

Each of the first matching circuit 121, the second matching circuit 122, and the third matching circuit 123 is one example of a matching part.

At least a part of the first antenna element 111 is arranged in an area that is sandwiched between portions of the conductor of the second antenna element 112 having a reciprocating meandering shape. Thus, the first antenna element 111 is capacitively coupled to the second antenna element 112. Therefore, the antenna apparatus 100 has a sensitivity for the frequency band of the AM broadcast that is equivalent to a sensitivity of a flat plate antenna element having an area that is equal to a sum of areas of the first antenna element 111 and the second antenna element 112.

The antenna amplifier 150 is a circuit that amplifies and outputs a signal received by each antenna element. The antenna amplifier 150 amplifies and outputs the signal for each antenna element. The antenna amplifier 150 outputs the amplified signal to a receiver for each frequency band.

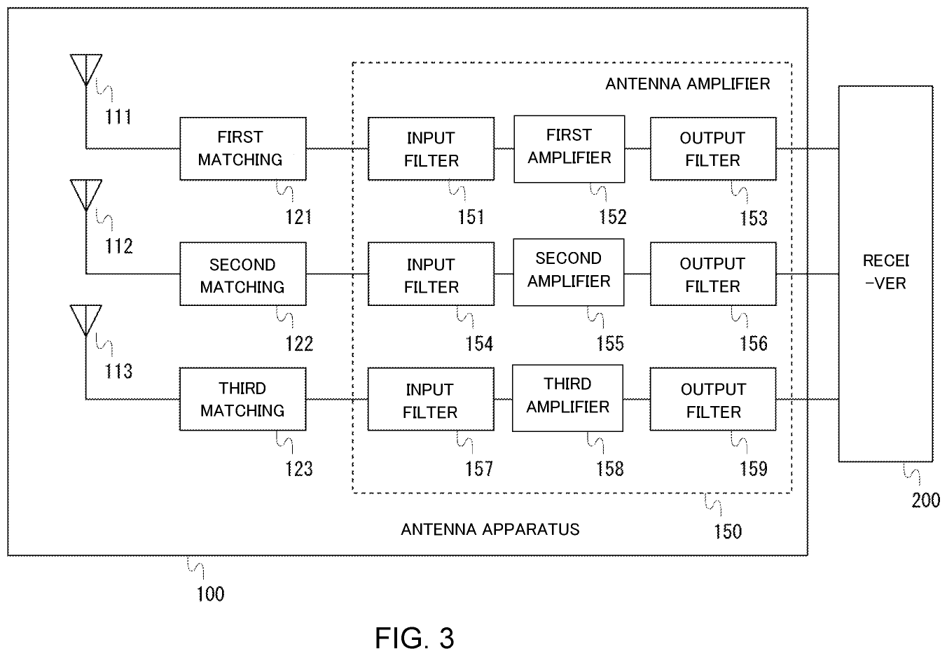

FIG. 3 illustrates an example of a functional block of the antenna apparatus according to this embodiment. The antenna apparatus 100 includes the first antenna element 111, the second antenna element 112, the third antenna element 113, the first matching circuit 121, the second matching circuit 122, the third matching circuit 123, and the antenna amplifier 150. The antenna amplifier 150 includes an input filter 151, a first amplifier 152 and an output filter 153 for the first frequency band, an input filter 154, a second amplifier 155 and an output filter 156 for the second frequency band, and an input filter 157, a third amplifier 158 and an output filter 159 for the third frequency band. An output signal from the antenna apparatus 100 is input to a receiver 200 for each frequency band. The receiver 200 is a radio, a television, or the like, that is mounted on in-vehicle device of the vehicle. The radio, or the like, receives the AM broadcast, the FM broadcast, and the DAB broadcast (DTV broadcast). The in-vehicle device is a car navigation system, an audio device, or the like.

The input filter 151 is arranged between the first matching circuit 121 and the first amplifier 152. The input filter 151 removes noise, or the like, in a signal from the first antenna element 111, and outputs the processed signal to the first amplifier 152.

The first amplifier 152 is arranged between the input filter 151 and the output filter 153. The first amplifier 152 amplifies the signal in the first frequency band that is input from the input filter 151, and outputs the amplified signal to the output filter 153.

The output filter 153 is arranged between the first amplifier 152 and the receiver 200. The output filter 153 removes noise, or the like, in the signal from the first amplifier 152, and outputs the processed signal to the receiver 200.

The input filter 154 is arranged between the second matching circuit 122 and the second amplifier 155. The input filter 154 removes noise, or the like, in a signal from the second antenna element 112, and outputs the processed signal to the second amplifier 155.

The second amplifier 155 is arranged between the input filter 154 and the output filter 156. The second amplifier 155 amplifies the signal in the second frequency band that is input from the input filter 154, and outputs the amplified signal to the output filter 156.

The output filter 156 is arranged between the second amplifier 155 and the receiver 200. The output filter 156 removes noise, or the like, in the signal from the second amplifier 155, and outputs the processed signal to the receiver 200.

The input filter 157 is arranged between the third matching circuit 123 and the third amplifier 158. The input filter 157 removes noise, or the like, in a signal from the third antenna element 113, and outputs the processed signal to the third amplifier 158.

The third amplifier 158 is arranged between the input filter 157 and the output filter 159. The third amplifier 158 amplifies the signal in the third frequency band that is input from the input filter 157, and outputs the amplified signal to the output filter 159.

The output filter 159 is arranged between the third amplifier 158 and the receiver 200. The output filter 159 removes noise, or the like, in the signal from the third amplifier 158, and outputs the processed signal to the receiver 200.

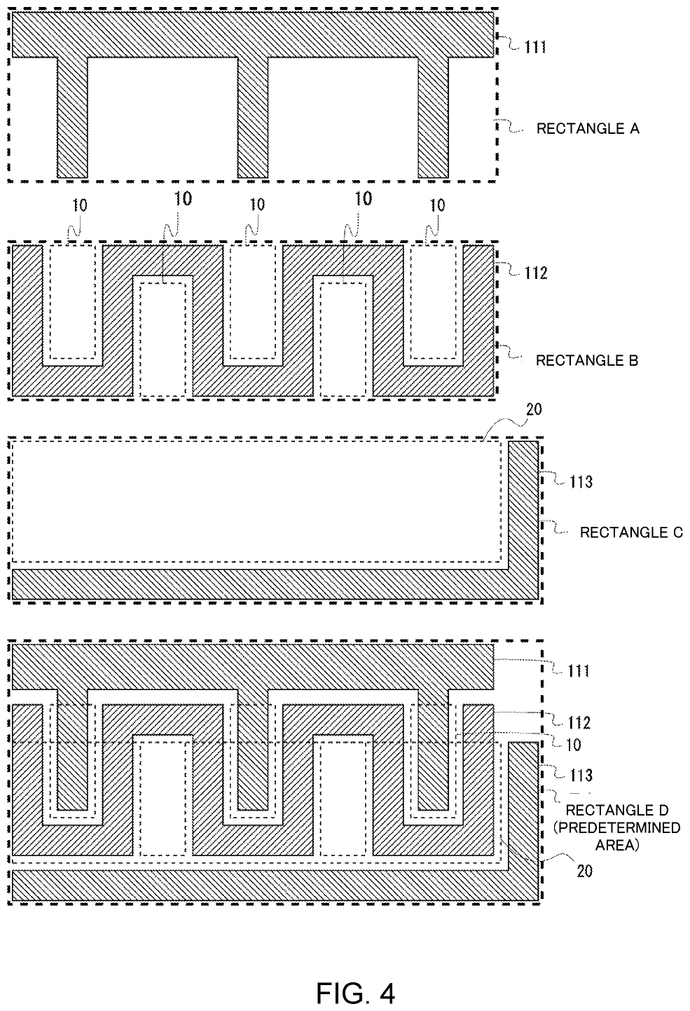

FIG. 4 illustrates an example of each antenna element. In FIG. 4, a rectangle A is a minimum rectangular area including the first antenna element 111. Each side of the rectangle A contacts a part of the first antenna element 111. A rectangle B is a minimum rectangular area including the second antenna element 112. Each side of the rectangle B contacts a part of the second antenna element 112. Within the rectangle B, there is a plurality of areas 10 each of which is sandwiched between portions of the conductor of the second antenna element 112 having a reciprocating meandering shape. A rectangle C is a minimum rectangular area of the rectangular area including the third antenna element 113 having an L shape. The rectangle C uses an outside of one side of the third antenna element 113 having an L shape and an outside of the other side perpendicular to the one side as two sides. Each side of the rectangle C contacts a part of the third antenna element 113. Within the rectangle C, there is an area 20 other than a portion of the conductor of the third antenna element 113.

In the substrate 105 of the antenna apparatus 100, a rectangle D is a predetermined area in which the first antenna element 111, the second antenna element 112 and the third antenna element 113 exist. In the predetermined area on the substrate 105, a part of the first antenna element 111 is arranged in a part of the plurality of areas 10 that is sandwiched between portions of the conductor of the second antenna element 112 having a reciprocating meandering shape. In the predetermined area on the substrate 105, a part of the first antenna element 111 and a part of the second antenna element 112 are arranged in a part of the area 20. As a result, an area of the predetermined area (rectangle D) in which the first antenna element 111, the second antenna element 112 and the third antenna element 113 exist is smaller than a sum of areas of the rectangles A, B and C. Thus, in the antenna apparatus 100, since the first antenna element 111, the second antenna element 112 and the third antenna element 113 are arranged as the rectangle D, an installation area of these antenna elements can be reduced compared to when these antenna elements are separately arranged.

Since the first antenna element 111 and the second antenna element 112 are close to each other, when receiving the radio wave in the first frequency band (frequency band of the AM broadcast), the first antenna element 111 is capacitively coupled to the second antenna element 112 (in other words, the first antenna element 111 and the second antenna element 112 are arranged close to each other so as to provide a capacitive coupling). Since the first antenna element 111 is capacitively coupled to the second antenna element 112, antenna capacity in the first frequency band (frequency band of the AM broadcast) is increased, and thus, a sensitivity of the antenna is improved. In the first frequency band, the sensitivity that is equivalent to a sensitivity of a flat plate antenna element having an area that is equal to a sum of the areas of the first antenna element 111 and the second antenna element 112 can be obtained.

When receiving the radio wave in the second frequency band (frequency band of the FM broadcast), the signal from the second antenna element 112 is amplified by the second amplifier 155 that amplifies the signal in the second frequency band. Since the signal from the second antenna element 112 is not divided and is input to the second amplifier 155, a branching loss is not caused, so that the sensitivity is improved.

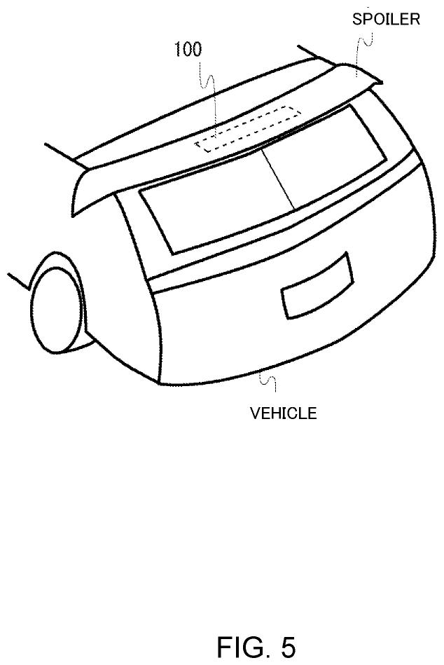

FIG. 5 illustrates an example in which the antenna apparatus is mounted on the vehicle. In the example of FIG. 5, the antenna apparatus 100 is installed in an interior of a spoiler that is provided above a rear part of the vehicle. The spoiler is a resin-made part for inhibiting lifting of the vehicle. Since the antenna apparatus 100 is installed in the interior of the spoiler, it is possible to install the antenna apparatus 100 without spoiling an appearance design of the vehicle. An output of the antenna apparatus 100 is connected via a predetermined coaxial cable, etc., to the receiver 200 in an interior of the vehicle. An installation position of the antenna apparatus 100 is not limited to the interior of the spoiler. The antenna apparatus 100 may be installed in an interior of a resin-made body, on a windshield, a roof glass, a door glass, a rear glass, etc.

### Operation and Effect of Embodiment

The antenna apparatus 100 includes the first antenna element 111 for the first frequency band, the second antenna element 112 for the second frequency band, and the third antenna element 113 for the third frequency band within the predetermined area of the substrate 105. The radio wave received by the first antenna element 111 is amplified by the first amplifier 152 for the first frequency band and is output to the receiver 200. The radio wave received by the second antenna element 112 is amplified by the second amplifier 155 for the second frequency band and is output to the receiver 200. The radio wave received by the third antenna element 113 is amplified by the third amplifier 158 for the third frequency band and is output to the receiver 200. An area of the predetermined area of the substrate 105 in which the first antenna element 111, the second antenna element 112 and the third antenna element 113 are arranged is smaller than a sum of areas of minimum rectangular areas of rectangular areas including the first antenna element 111, the second antenna element 112 and the third antenna element 113. According to the antenna apparatus 100, compared to a configuration in which the antenna elements are separately arranged, the installation area of the antenna elements can be reduced. That is, according to the antenna apparatus 100, since the limited area of the predetermined area in the substrate 105 can be effectively utilized, a size of the antenna apparatus 100 can be reduced. As a result, according to the antenna apparatus 100, it is possible to improve an appearance of the vehicle or mountability on the vehicle.

According to the antenna apparatus 100, when receiving the radio wave in the first frequency band, since the first antenna element 111 is capacitively coupled to the second antenna element 112, the antenna capacity is increased. According to the antenna apparatus 100, since the antenna capacity is increased, the sensitivity of the antenna for the first frequency band is improved.

According to the antenna apparatus 100, since the radio wave in the first frequency band and the radio wave in the second frequency band are received by different antenna elements and are amplified, a branching loss of the radio waves in respective frequency bands is not caused, and thus the sensitivity of the antenna is improved.

According to the antenna apparatus 100, since the second matching circuit 122 is designed to be high impedance for the signal in the third frequency band, and further, the third matching circuit 123 is designed to be high impedance for the signal in the second frequency band, even when the second antenna element 112 and the third antenna element 113 are arranged close to each other as independent elements, mutual interference can be reduced.

### Modification

A modification example of the embodiment will be described. The modification example has common points with the embodiment. Here, different points from the embodiment will be mainly described, and description of common points will be omitted.

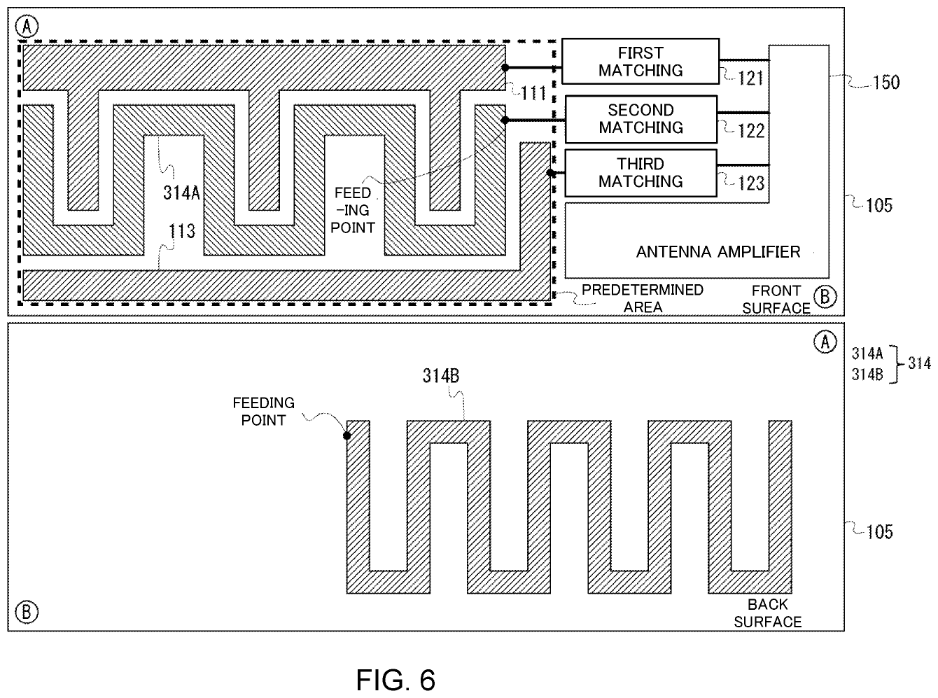

FIG. 6 illustrates a configuration example of an antenna apparatus according to the modification example. The antenna apparatus 100 shown in FIG. 6 includes a substrate 105, a first antenna element 111, a second antenna element 314, a third antenna element 113, a first matching circuit 121, a second matching circuit 122, a third matching circuit 123, and an antenna amplifier 150. An upper drawing of FIG. 6 illustrates a front surface (a first surface) of the substrate 105 of the antenna apparatus 100 according to the modification example, and a lower drawing of FIG. 6 illustrates a back surface (a second surface) of the substrate 105 of the antenna apparatus 100 according to the modification example. The front surface shown in the upper drawing of FIG. 6 is laterally reversed and turned over to become the back surface shown in the lower drawing of FIG. 6. A mark “A” on the back surface is positioned on a back side of a mark “A” on the front surface, and a mark “B” on the back surface is positioned on a back side of a mark “B” on the front surface.

The second antenna element 314 includes a first meandering portion 314A that is arranged on the front surface and a second meandering portion 314B that is arranged on the back surface. The second antenna element 314 has a double meandering shape formed of the first meandering portion 314A and the second meandering portion 314B. The front surface of the substrate 105 is similar to the substrate 105 of the embodiment described above. The first meandering portion 314A on the front surface of the substrate 105 is similar to the second antenna element 112 of the embodiment described above. The back surface of the substrate 105 includes the second meandering portion 314B. The second meandering portion 314B is an antenna element having a meandering shape. The second meandering portion 314B is electrically connected to the first meandering portion 314A on the front surface via a conductor passed through a through hole in a vicinity of the first meandering portion 314A on the front surface (i.e., a through-hole conductor, etc.). A connection portion between the first meandering portion 314A and the second meandering portion 314B becomes a feeding point and the feeding point is connected to the second matching circuit 122.

A size of an antenna element of the second meandering portion 314B (an antenna length, an antenna width, a number of times of folding, folding intervals, a diameter of the conductor, etc.) is different from a size of an antenna element of the first meandering portion 314A. A frequency band that can be received by the antenna element having a meandering shape depends on the size of the antenna element. Since the size of the antenna element is different between the first meandering portion 314A and the second meandering portion 314B, the second antenna element 314 can receive a radio wave in a frequency band based on the size of the antenna element of the first meandering portion 314A and a radio wave in a frequency band based on the size of the antenna element of the second meandering portion 314B. The second antenna element 314 can receive a radio wave in a wider frequency band than the second antenna element 112.

The above-mentioned embodiment and the modification example may be combined and implemented as long as no technical contradiction occurs.

While the invention has been shown and described in detail, the foregoing description is in all aspects illustrative and not restrictive. It is therefore understood that numerous other modifications and variations can be devised without departing from the scope of the invention.

What is claimed is:

1. An antenna apparatus comprising:
a dielectric substrate;
a first antenna element that is arranged within a predetermined area on the dielectric substrate and receives a first radio wave in a first frequency band;
a second antenna element that is arranged within the predetermined area on the dielectric substrate and receives a second radio wave in a second frequency band different from the first frequency band; and
a third antenna element that is arranged within the predetermined area on the dielectric substrate and receives a third radio wave in a third frequency band different from the first frequency band and different from the second frequency band, wherein
the first antenna element is arranged in a first portion of the predetermined area on the dielectric substrate,
the second antenna element is arranged in a second portion of the predetermined area on the dielectric substrate in which the first antenna element is not arranged,
the third antenna element is arranged in a third portion of the predetermined area on the dielectric substrate in which the first antenna element and the second antenna element are not arranged,
the first antenna element is contained within a first rectangular area that is within the predetermined area, the first rectangular area being a smallest rectangle that circumscribes the first antenna element,
the second antenna element is contained within a second rectangular area that is within the predetermined area, the second rectangular area being a smallest rectangle that circumscribes the second antenna element,
the third antenna element is contained within a third rectangular area that is within the predetermined area, the third rectangular area being a smallest rectangle that circumscribes the third antenna element, and
an area of the predetermined area is smaller than a sum of areas of the first rectangular area, the second rectangular area and the third rectangular area.

2. The antenna apparatus according to claim 1, wherein
the first frequency band is a frequency band of AM (Amplitude Modulation) broadcast, the second frequency band is a frequency band of FM (Frequency Modulation) broadcast, and the third frequency band is a frequency band of DAB (Digital Audio Broadcasting) broadcast or DTV (Digital Television) broadcast.

3. The antenna apparatus according to claim 1, wherein
the second antenna element has a meandering shape.

4. The antenna apparatus according to claim 3, wherein
at least a part of the first antenna element is arranged in an area that is sandwiched between portions of a conductor of the second antenna element having a reciprocating meandering shape.

5. The antenna apparatus according to claim 3, wherein
the dielectric substrate has a first surface and a second surface that is a back surface with respect to the first surface, and the second antenna element has a double meandering shape in which a first meandering portion is formed on the first surface and a second meandering portion is formed on the second surface.

6. The antenna apparatus according to claim 5, wherein
a size of the first meandering portion is different from a size of the second meandering portion.

7. The antenna apparatus according to claim 1, wherein
the third antenna element has an L shape.

8. The antenna apparatus according to claim 1, further comprising;
a first matching part that is connected to the second antenna element; and
a second matching part that is connected to the third antenna element, wherein
the first matching part is designed to be high impedance for a signal in the third frequency band, and
the second matching part is designed to be high impedance for a signal in the second frequency band.

9. The antenna apparatus according to claim 1, wherein
the first, second and third rectangular areas particularly overlap each other.

10. The antenna apparatus according to claim 1, wherein
the first and second rectangular areas particularly overlap each other in an overlap area,
a part of the first antenna element is located in first portions of the overlap area,
a part of the second antenna element is located in second portions of the overlap area, and
the first and second portions of the overlap area are alternately arranged.

11. The antenna apparatus according to claim 1, wherein
the dielectric substrate is plate-shaped.

12. The antenna apparatus according to claim 1, wherein
the dielectric substrate is flat.

13. The antenna apparatus according to claim 1, wherein
the dielectric substrate is curved.
